(19) United States
(12) Patent Application Publication
(10) Pub. No.: US 2002/0171546 A1
(43) Pub. Date: Nov. 21, 2002

(54) Universal, customizable security system for computers and other devices

(76) Inventors: Thomas P. Evans, Watertown, MA (US); W. David Lee, West Newton, MA (US); C. Gail Greenwald, Winchester, MA (US); Christopher Verplaetse, Somerville, MA (US)

Correspondence Address: Iandiorio & Teska, INTELLECTUAL PROPERTY LAW ATTORNEYS, 260 BEAR HILL ROAD, WALTHAM, MA, 02451-1018, US

(21) Appl. No.: 10/124,104

(22) Filed: Apr. 17, 2002

Related U.S. Application Data
(60) Provisional application No. 60/284,536, filed on Apr. 18, 2001.

(51) Int. Cl. G08B 21/00

(52) U.S. Cl. 340/540; 340/568.1; 340/571; 340/5.2; 340/5.8; 340/5.85; 713/182

(57) ABSTRACT

A universal, customizable computer security system including a set of security input signals each relating to a possible security event and a rules engine with a universal software interface responsive to the security input signals. The rules engine is configurable to perform one or more security actions in response to each security input signal. The rules engine further includes a user interface program to allow a user to select one or more customized security actions for a combination of one or more chosen security input signals, and a universal software output interface responsive to the selected security actions.

### RELATED APPLICATIONS

This application claims priority of U.S. Utility application Ser. No. 09/572,801 filed May 17, 2000; 09/773,165 filed Jan. 31, 2001; and Provisional Application No. 60/284,536 filed Apr. 18, 2001. All of these applications are incorporated by reference herein.

### FIELD OF THE INVENTION

This invention relates to a computer security system and more particularly, to a universal, customizable computer security system.

### BACKGROUND OF THE INVENTION

Currently, there are numerous computer security systems which can detect a wide range of security input signals and respond with one or more security actions based on the security input signal detected. For example, anti-virus software can be configured to detect the presence of a virus on the hard drive and respond with customized security actions such as notifying the user of the presence of the virus and deleting the virus. User authentication systems may deny access to the system after a predefined number of unsuccessful login attempts. The inventors hereof devised a PC-card laptop computer security system that can detect a theft event and respond with various customized security actions, such as sounding a piercing audio alarm, shutting down the computer, and/or making the computer inoperable until the correct security codes or motion passwords are entered. In other systems, radio frequency (RF) badges worn on users can authenticate and log the user on and off a computer when the RF badges are within a predetermined distance of the computer. Also, biometric login security systems employing fingerprint or voice recognition can be used for user authentication into a computer system. Arming/disarming security systems can be customized to detect various security breaches and respond by locking access to the hard drive of the computer, shutting down the computer, or even erasing all data on hard drive if desired. Encryption security systems can respond to specific security events by encrypting all or portions of data on a computer depending on the level of the security breach. Other security systems can initiate trace and callback programs in response to various security input signals.

However, each of these discrete security systems must be individually configured to respond to a specific set of security input signals and further configured by the user to select the security actions which will be performed in response to the various selected security input signals. Moreover, each of these security systems require separate software programs to process the security input signals and perform the desired security actions and a separate interface between the input security signals and the security software. Finally, the prior art security systems do not generally interact with each other. Hence, customization of a combination of security input signals and security actions from each of the isolated security systems is difficult especially if the user is not skilled in the art of processors and computer programs.

### BRIEF SUMMARY OF THE INVENTION

It is therefore an object of this invention to provide a more universal and customizable computer security system.

It is a further object of this invention to provide such a security system which is customizable so that the user can more easily select a combination of one or more security input signals provided by multiple security systems.

It is a further object of this invention to provide such a security system which is user customizable to perform selected combinations of security actions in response to chosen security input signals.

It is a further object of this invention to provide such a security system which provides a simple and easy way for a user to select the security input signals provided by multiple security systems and software applications and to also select the security actions to be performed in response to the chosen input signals.

It is a further object of this invention to provide such a security system which eliminates the need for separate interfaces between the security input signals and the security software for each security system.

It is a further object of this invention to provide such a security system which eliminates the need for writing and implementing separate security software programs for each of the multiple security systems.

The invention results from the realization that a truly effective universal, customizable, and integrated security system can be achieved by providing a robust rules engine which can be customized via a unique user interface program, which is simple and easy to operate to perform a combination of one or more security actions from multiple security systems in response to a customized set of selected security input signals which relate to security events. The security system also includes a universal software interface which integrates the security input signals and security actions from the various security systems with the rules engine.

This invention features a universal, customizable computer security system comprising a set of security input signals each relating to a possible security event, and a rules engine with a universal software interface responsive to the security input signals. The rules engine is configurable to perform one or more security actions in response to each security input signal. The rules engine further includes a user interface program to allow a user to select one or more customized security actions for a combination of one or more chosen security input signals, and a universal software output interface responsive to the selected security actions.

In one embodiment of this invention, the security input signals correspond to motion, warning of unauthorized motion, a theft event, a motion password event, a proximity sensor signal, a zone sensor signal, a location sensor signal, an environmental security threat, detection of virus, detection of a firewall problem, connection or disconnection from a network, connection or disconnection of an A/C adapter, connection or disconnection of a docking station, connection or disconnection of a battery, connection or disconnection of a hard drive, authentication inputs including password, motion password, biometric, token, badge, and smart card, failed log-in attempt, unexpected or prohibited keyboard entries, unexpected or prohibited internet connections, user log on, user log off, unexpected user log in, user log in at unexpected times, unexpected user or administrator behavior, other hacker detection methods, unexpected file move or copy behavior, operating system suspend, operating system hibernate, or screen saver.

Typically, the security actions correspond to notification of individual, group, entire network, or authority, notification via internet, modem, wired LAN, or wireless LAN, pop up warning to user, forced log off, prohibit log on, change arming state, such as disarm to arm, shut down of computer and/or system, lock keyboard or mouse, turn off monitor, encrypt files, erase files, move files, destroy content of disk, sound an alarm, send location information, enable or disable boot block, change boot sequence, enable or disable hard drive lock, enable or disable operating system lock, connect or disconnect from network, prohibit access to files, applications, or servers, reset passwords, change authentication requirements, change access privileges for certain users, data, applications, or servers, deny access to encryption keys, enable or disable internet connection, or enable or disable e-mail.

The rules engine may be configured to prioritize the security actions performed based on conditional relations selected. Ideally, the user interface program configures the security actions based on the conditional relations selected. Preferably, the user interface program is a graphical user interface. In one example of this invention, the set of available security input signals are generated by a plurality of security systems.

### BRIEF DESCRIPTION OF THE DRAWINGS

Other objects, features and advantages will occur to those skilled in the art from the following description of a preferred embodiment and the accompanying drawings, in which:

FIG. 1 is a block diagram of a typical prior art security system showing a single security input signal, an interface, and a software program which responds to the security input signal with various security actions;

FIG. 2 is a block diagram of two discrete security systems showing the separate security input signals, separate interfaces, separate security software, and separate security actions required for each system in accordance with the prior art;

FIG. 3 is a block diagram showing the primary components associated with one embodiment of the universal, customizable security system of the subject invention;

FIG. 4 is a block diagram showing one example of a customized combination of security input signals and security actions;

FIG. 5 is a block diagram showing another example of a customized combination of security input signals and security actions; and

FIG. 6 is a block diagram showing one embodiment of the user interface program of this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

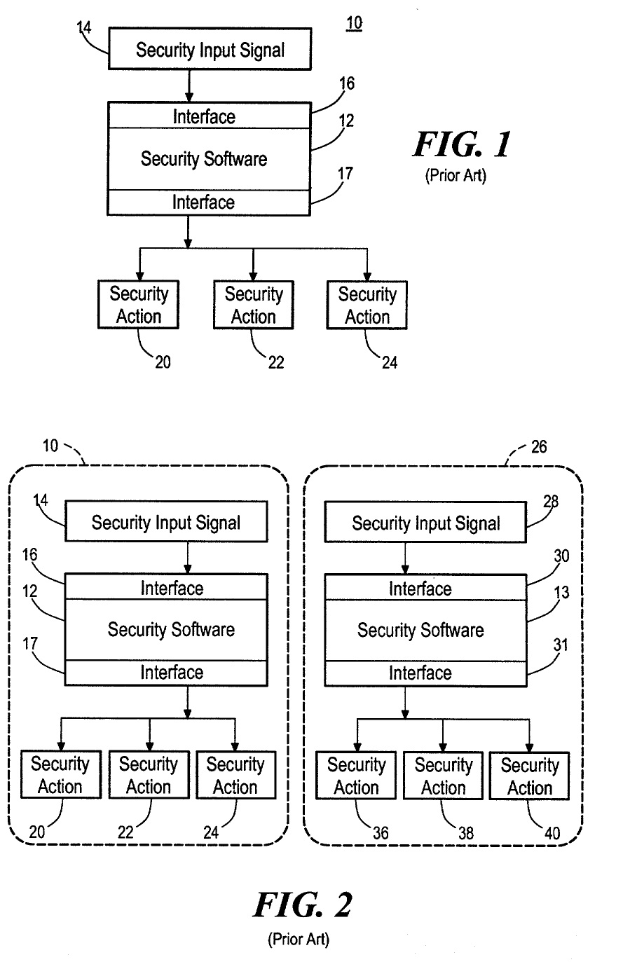

As explained in the Background section, typical prior art security system 10, FIG. 1, includes security software 12 which must be configured by the user to respond to selected security input signal 14 which relates to a possible security event. Security software 12 is further configured to perform a combination of one or more security actions 20, 22, and 24 in response to security input signal 14. System 10 also includes interface 16 which provides the necessary connectivity between security input signal 14 and security software 12. System 10 also includes interface 17 which provides the necessary connectivity between software 12 and security actions 20, 22, and 24.

For example, prior art security system 10 may be one of the well known antivirus security systems and configured to respond to security input signal 14 such as detection of a virus on the hard-drive. Software 12 is configured to respond to the detection of the virus by security actions 20, 22, and/or 24 (e.g., sending a message to the user, sounding an alarm, and disinfecting the virus). Interfaces 16 and 17 provide the interconnection between the software of the anti-virus security system with the operating system of the user's computer or network.

As shown above, security input signal 14 to be detected by system 10 as well as security actions 20-24 to be performed in response to security input signal 14 must be configured by the user. Moreover, security system 10 has its own dedicated interfaces 16 and 17 and its own dedicated security software 12.

If an additional security system is added to the computer, such as RF badge type security system 26, FIG. 2, additional security software 13 is required as well as additional interfaces 30 and 31. Further, system 26 must be configured to respond to the security input signal 28 and also configured to perform the desired security actions 36, 38, and 40 in response to security input signal 28. But, anti-virus security system 10 will not interface with RF badge security system 26.

In another example, adding a security login system to a computer that already has an anti-virus security system installed would require installation of separate security login software program and a separate interface specific to the login security system. Moreover, the security input signal for the anti-virus software and the security input signals from the security login software, and the corresponding security actions performed by each system are isolated from each other. The two systems cannot be customized to respond to each other's security input signals, and/or respond with a combination of security actions from each of the two systems. That is, security system 10 does not respond to security input signal 28 and security system 26 does not respond to security input signal 14. And, security system 10 does not perform security actions 36, 38, and 40 and security system 26 does not perform security actions 20, 22, and 24 even though there may be overlap between these actions. Moreover, security systems 10 and 26 each have and require their own dedicated security software code (security software 12 and 13) and their own interfaces (interfaces 16, 17 and 30, 31) to provide necessary connectivity between the input security signals and the security software.

The subject invention provides the first integrated customizable security system capable of managing and securing a universal range of computer systems from the individual application to the local area network (LAN) and the internet. The focus of prior art security systems of MICROSOFT® and other companies has been to detect threats by attackers. This invention recognizes that the LAN and the internet are both a source of attacks, and they also offer an ideal means for response to such attacks. The LAN, wireless area network (WAN), and the internet can be part of the threat response by notifying a central station of an attack or threat, locating a stolen computer by IP address or wireless methods, recovering data from a stolen computer, or locking certain data on a computer.

Computer security system 50 of the subject invention will work seamlessly with third party LAN and internet threat detection software to provide the desired detection and response while, at the same time, enabling the effective use of the communications channels to enhance security. This invention reverses the one-way view that the internet is the sole source of security attacks.

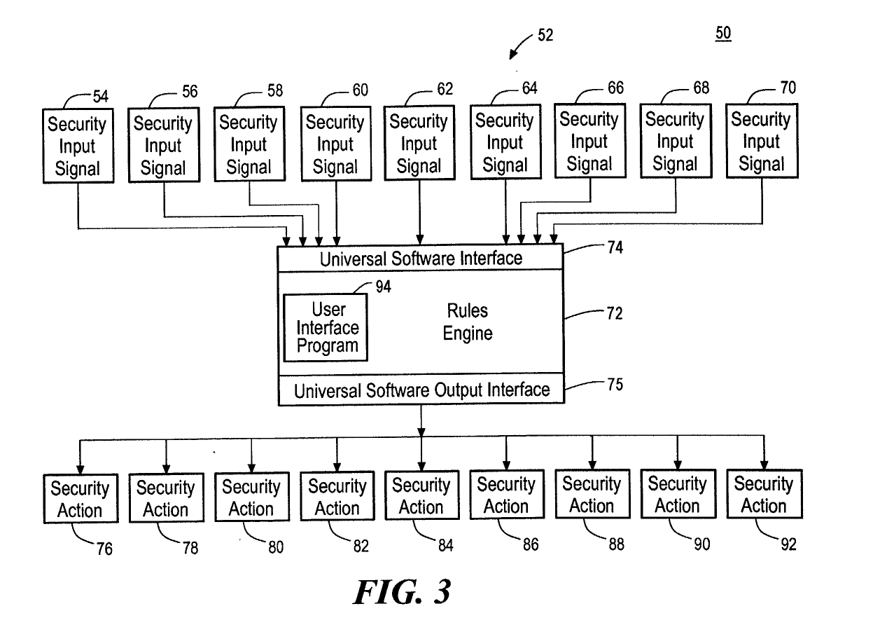

In sharp contrast to the prior art, universal and customizable security system 50, FIG. 3 of the subject invention includes set 52, in one example, of security input signals 54-70, each relating to a wide variety of possible security events. Security system 50 also uniquely includes rules engine 72 with universal software interface 74 which is responsive to security input signals 54-70. Security system 50 also has universal software output interface 75 which is responsive to rules engine 72 and provides control signals to security actions 76-92. Rules engine 72 is configurable to perform a wide variety of possible security actions 76-92 in response to each security input signal 54-70, or any selected combinations of the same, and further includes user interface program 94 which allows a user to select one or more customized security actions 76-92 for a combination of one or more chosen security input signals 54-70. Rules engine 72 and user interface program 94 permit the user to define complex functional relationships between the security related inputs and the security actions based on user selected conditional relations as discussed below.

Universal software interfaces 74 and 75 provide the connectivity between rules engine 72 and the software applications that represent the security related inputs and security actions. Universal software interface 74 permits bidirectional communication which allows security input signals 54-70 to either actively transmit events to rules engine 72 or to be passively polled for security status by rules engine 72. Similarly, universal software output interface 75 provides the necessary connectivity between rules engine 72 and security actions 76-92.

Rules engine 72 is designed and configured to respond to security input signals 54-70 which each relate to possible security events provided by the host operating system and by multiple discrete security systems available from different companies by performing any combination of security actions 76-92 based on any combination of selected security input signals 54-70. This novel design thus integrates the various security input signals and security actions from multiple diverse security systems. Moreover, rules engine 74 eliminates the need for separate security software programs which are responsive to the various security input signals and which respond with various security actions. The unique design of universal software interface 74, discussed infra, is responsive to security input signals 54-70 and eliminates the need for separate interfaces between each security input signal 54-70 and the separate security software programs for each system. Universal software output interface 75 similarly eliminates the need for separate interfaces between separate security software programs and each security action 76-96. User interface program 94 allows users to customize and prioritize both the security input signals to be detected by security system 50 and the security actions to be performed in response to the selected, customized security input signals. The unique design of security system 50 overcomes the isolation of security input signals 54-70 from each other and, moreover, removes the isolation of security actions 76-92 from each other and from security input signals 54-70. The result is a robust universal, customizable security system which is integrated such that the system can detect a wide range of security input signals from a multitude of security systems and perform a vast combination of customized security actions based on the selected security input signals.

In one example, set 50 of customizable security input signals 54-70 may correspond to warning of unauthorized motion, a theft event, and a motion password event produced, for example, by the security system called CAVEO™ ANTI-THEFT™ (Caveo Technology, LLC, Cambridge, Mass.), motion, such as from a motion sensor, a proximity sensor signal, for example RF badge presence or token presence, a zone sensor signal, such as presence of wireless zone, a location sensor signal, such as Global Positioning Signal (GPS), an environmental security threat, for example a theft in the vicinity or suspicious person on the premises, virus detection, detection of a firewall problem, connection or disconnection from a network, connection or disconnection of an A/C adapter, connection or disconnection of a docking station, connection or disconnection of a battery, connection or disconnection of a hard drive, various authentication inputs including password, motion password, biometric, token, badge, and smart card, failed log-in attempt, unexpected or prohibited keyboard entries, unexpected or prohibited internet connections, user log on or user log off, unexpected user log in, user log in at unexpected times, unexpected user or administrator behavior, such as that generated by hacker, other hacker detection methods, unexpected file move or copy behavior, operating system suspend, hibernate, and screen saver.

Typical security actions 76-92 performed in response to security input signals 54-70 may correspond to notification of individual, group, entire network, or authority, notification via internet, modem, wired LAN, or wireless LAN, pop-up warning to a user, forced log off, prohibit log on, change arming state, such as to disarm or arm, shutting down the computer or system, lock keyboard or mouse, turn off monitor, encrypt files, erase files, move files, destroy contents of disk, sound alarm, send location information, enable or disable boot blocking, change boot sequence, enable or disable hard drive lock, enable or disable operating system lock, connect or disconnect from network, prohibit access to files, applications, servers, reset passwords, change authentication requirements, change access privileges for certain users, data applications, or servers, deny access to encryption keys, enable or disable internet connection, or enable or disable e-mail.

Signals from a wireless LAN connection may also serve as security inputs. For example, the system 50 may detect when a laptop computer moves between zones covered by different wired or wireless LAN cells or repeaters.

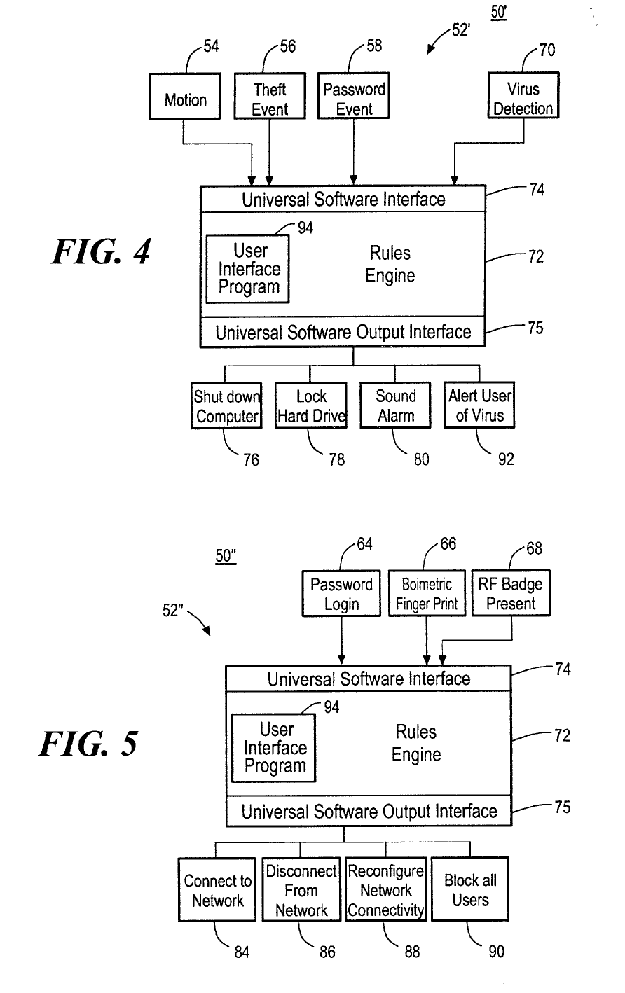

In one example in accordance with this invention, system 50′, FIG. 4 includes a customized set 52′ of security input signals (e.g., security events) which may include warning of motion signal 54, a theft event signal 56, and motion password event signal 58 produced by CAVEO™ ANTI-THEFT™ software, and virus detection signal 70, produced by NORTON® anti-virus software. Rules engine 72 with universal software interface 74 is responsive to a motion signal 54, theft event signal 56, motion password event signal 58, and virus detection signal 70 and is configured, in this example, to perform any combination of one or more user selected security acts by way of interface 75, such as shutting down the computer 76, locking the hard drive 78, sounding an alarm 80, and alerting the user of virus detection 92 based on any selected combination security input signals 54, 56, 58 and 70. For example, if rules engine 72 responds to virus detection signal 70 it can be user configured to perform any combination of security acts 76-80, such as shutting down the computer 76, locking the hard drive 78, sounding alarm 80, and alerting the user of virus detection 92. The unique user interface program 94 of the subject invention allows a user to select any combination of security input signals produced by the various security systems and any combination of corresponding security actions to be performed. Unlike prior art security systems, wherein for example, detection of a virus only allows the security system to alert the user of the virus and delete the virus, the unique universal, customizable security system of the subject invention provides the ability to not only perform the security action associated with the anti-virus software, but to also perform the security acts associated with, in this example, the CAVEO™ ANTI-THEFT™ software, such as shutting down the system, locking the hard drive and/or sounding a piercing alarm. In this example, the user may choose to have the computer shut down when a virus is detected to protect the system from further virus attacks.

In another typical example, universal, customizable security system 50″, FIG. 5 includes rules engine 72 with universal software interface 74 which is responsive to password log in signal 64, biometric fingerprint device signal 66, and RF badge present signal 68. Rules engine 72 is configured to perform the security actions of connecting to the network 84, disconnecting from the network 86, reconfiguring the network connectivity 88, and blocking all users from logging on 90. Similarly, as shown above, system 50″ with rules engine 72, universal software interfaces 74 and 75, and user interface program 94 is customizable to perform any combination of the security actions of connecting to the network 84, disconnecting from the network 86, reconfiguring the network connectivity 88, and blocking all users from logging on 90 in response to any selected combination of security input signals of password log in signal 64, biometric fingerprint device signal 66, and RF badge present signal 68. Although each of the security input signals 64, 66 and 68 may be produced by separate and distinct security systems, the universal, customizable security system of the subject invention allows these security input signals to be integrated and rules engine 72 to respond to the selected security input signals with a customized combination of security actions 84, 86, 88 and 90.

Thus, at one extreme, in a highly secure system, the user can select many different security actions if the computer is moved in an unauthorized manner, if a virus is detected, if the RF badge is not present, or if the wrong password is not entered such as sounding an audible alarm, locking the hard drive of the computer, disconnecting the hard drive from the computer, and the like. At the other extreme, the user of a less secure system may only desire a message displayed on the computer screen if a virus is detected or the wrong password was entered and not select any action if the computer is moved or if the RF badge is not present.

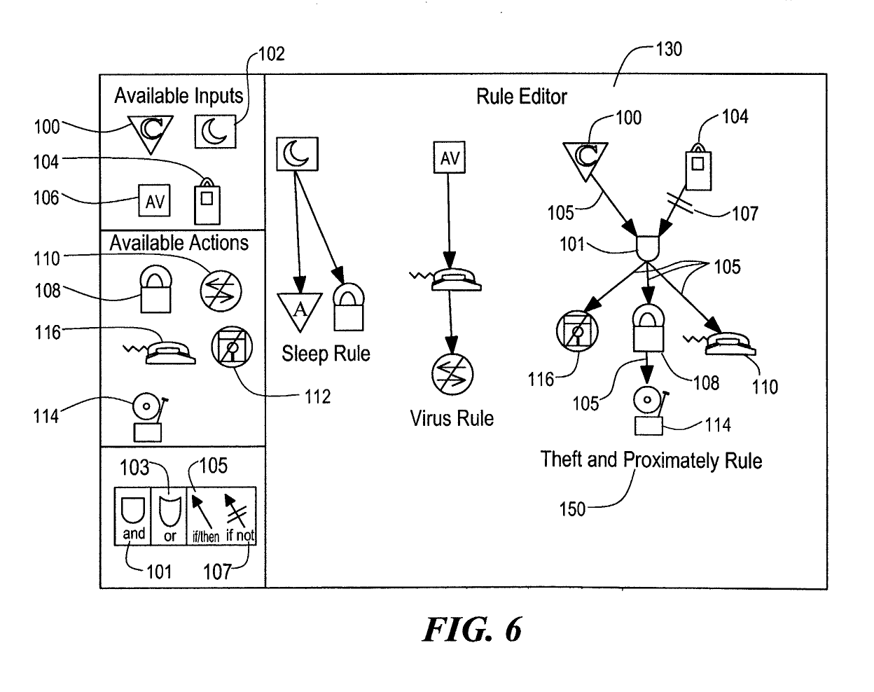

In one embodiment of the subject invention, user interface 94, FIG. 6 is a graphical user interface (GUI), and includes graphical representations (e.g., icons) of various installed security input signals, such as motion detection signal 100, screensaver activation signal 102, proximity badge detection signal 104, and virus detection signal 106. Available security actions are also graphically represented and may, in one example, include locking the computer 108, disabling communications 110, erasing sensitive data 112, sounding an alarm 114, and call trace-back recovery 116. A user then selects one or more of the various security input signals 100, 102, 104, 106, security actions 108, 110, 112, 114, 116, and the conditional relations 101, 103, 105, and 107 from toolbox 120 and places the graphical representations of the security inputs, security actions, and security relations into rules editor area 130 which is integrated with rules engine 72. Security input signals 100-106 and security actions 108-116 can be configured and customized in any combination by simply dragging and dropping the desired icons for security input signals 100-106, security actions 108-116, and conditional relations 101-107 from toolbox 120 into rules editor area 130. For example, theft and proximity rule 150 can be customized by a user to perform security acts of locking the computer 108, disabling communications 110, erasing sensitive data 112, sounding alarm 114, and call trace-back recovery 116 in response to the states of motion detection signal 100 and proximity badge detection signal 104 based on any combination of conditional relations 101-107 (e.g., “if, then”, “if not, then”, “and”, and “and or”) simply by dragging the selected security input icons and security action icons, dropping them into rules editor area 130, and connecting them via conditional relations 101, 103, 105, and 107 in the desired manner to achieve a particular behavior.

Universal customizable computer security system 50 of this invention generally depicted in FIG. 3 provides a transparent way to integrate and control all the components in the secure client environment and allow for vast flexibility and configuration options for the end user or a security administrator. Security input signals 54-70 and security actions 76-92 are coordinated by user interface 94 and rules engine 72, via interfaces 74 and 75. Rules engine 72 is a moderator among all cooperating security inputs 54-70 and security actions 76-92. Rules engine 72 is the engine that processes the security rules. Rules engine 72 is in essence a “language” which allows querying the state of various components registered to security system 50 and reacts to the status in a way defined by the user or the user's security organization. Processing of these rules will happen at various predefined “security evaluation” points, for example start up, shut down, log in, log out, and screensaver. In addition any components registered within the framework will have the ability to actively cause evaluation of the rules contained within the current security profile, hence allowing for both active and passive security objects. User interface 94 is responsible for the configuration and setup of the security of the secure client. For example, user interface 94 could allow for rules to be processed based on the binary status of each object. Each individual security input signal 54-70 and security actions 76-92 can also be configured via the vendor's standard provider user interface, or with user interface program 94 which allows rules to be created by a simple drag-and-drop, as discussed supra where each of the security components could be dropped into a space representing a particular system event at which evaluation needs to be performed.

In one example of this invention, the integration design employs object type oriented designs where each component (e.g., security input signals 54-70 and security actions 76-92) is implemented as a COM control (on MICROSOFT® operating systems platforms) using interface 74 or 75 that permits the agent/object to be queried and scripted. Rules engine 72 could be implemented by one of many existing scripting languages that support COM scripting such as VISUAL BASIC™. Alternatively, a byte code machine, or a native machine code language compiler could be used.

As shown above, the robust universal, customizable security system of the subject invention integrates the various security input signals and security actions from multiple security systems. The unique rules engine eliminates the need for separate security software programs required by each security system. The simple and easy to use user interface program provides for customization of the security input signals to be detected and the security actions to be performed in response to the selected security input signals. The security system in accordance with this invention is a powerful and effective means to process a wide range of security input signals from a multitude of security systems and perform a vast combination of customized security actions based on the selected security input signals.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A universal, customizable computer security system comprising:
a set of security input signals each relating to a possible security event; and
a rules engine with a universal software interface responsive to the security input signals, the rules engine configurable to perform one or more security actions in response to each security input signal, the rules engine further including a user interface program to allow a user to select one or more customized security actions for a combination of one or more chosen security input signals, and a universal software output interface responsive to the selected security actions.

2. The security system of claim 1 in which the security input signals correspond to motion, warning of unauthorized motion, a theft event, a motion password event, a proximity sensor signal, a zone sensor signal, a location sensor signal, an environmental security threat, detection of virus, detection of a firewall problem, connection or disconnection from a network, connection or disconnection of an A/C adapter, connection or disconnection of a docking station, connection or disconnection of a battery, connection or disconnection of a hard drive, authentication inputs including password, motion password, biometric, token, badge, and smart card, failed log-in attempt, unexpected or prohibited keyboard entries, unexpected or prohibited internet connections, user log on, user log off, unexpected user log in, user log in at unexpected times, unexpected user or administrator behavior, other hacker detection methods, unexpected file move or copy behavior, operating system suspend, operating system hibernate, or screen saver.

3. The security system of claim 1 in which the security actions correspond to notification of individual, group, entire network, or authority, notification via internet, modem, wired LAN, or wireless LAN, pop up warning to user, forced log off, prohibit log on, change arming state such as disarm to arm, shut down of computer and/or system, lock keyboard or mouse, turn off monitor, encrypt files, erase files, move files, destroy content of disk, sound an alarm, send location information, enable or disable boot block, change boot sequence, enable or disable hard drive lock, enable or disable operating system lock, connect or disconnect from network, prohibit access to files, applications, or servers, reset passwords, change authentication requirements, change access privileges for certain users, data, applications, or servers, deny access to encryption keys, enable or disable internet connection, or enable or disable e-mail.

4. The security system of claim 1 in which the rules engine is configurable to prioritize the security actions performed based on conditional relations selected.

5. The security system of claim 4 in which the user interface program configures the security actions based on the conditional relations selected.

6. The security system of claim 1 in which the user interface program is a graphical user interface.

7. The security system of claim 1 in which the set of available security input signals are generated by a plurality of security systems.

8. A universal, customizable computer security system comprising:
a set of security input signals each relating to a possible security event; and
a rules engine responsive to the security input signals, the rules engine configurable to perform one or more security actions in response to each security input signal, the rules engine further including a user interface program to allow a user to select one or more customized security actions for a combination of one or more chosen security input signals.

9. The security system of claim 8 further including a universal software interface responsive to the set of security input signals.

10. The security system of claim 8 further including a universal software output software interface responsive to the security actions.

11. The security system of claim 8 in which the security input signals correspond to motion, warning of unauthorized motion, a theft event, a motion password event, a proximity sensor signal, a zone sensor signal, a location sensor signal, an environmental security threat, detection of virus, detection of a firewall problem, connection or disconnection from a network, connection or disconnection of an A/C adapter, connection or disconnection of a docking station, connection or disconnection of a battery, connection or disconnection of a hard drive, authentication inputs including password, motion password, biometric, token, badge, and smart card, failed log-in attempt, unexpected or prohibited keyboard entries, unexpected or prohibited internet connections, user log on, user log off, unexpected user log in, user log in at unexpected times, unexpected user or administrator behavior, other hacker detection methods, unexpected file move or copy behavior, operating system suspend, operating system hibernate, or screen saver.

12. The computer security system of claim 8 in which the security actions correspond to notification of individual, group, entire network, or authority, notification via internet, modem, wired LAN, or wireless LAN, pop up warning to user, forced log off, prohibit log on, change arming state such as disarm to arm, shut down of computer and/or system, lock keyboard or mouse, turn off monitor, encrypt files, erase files, move files, destroy content of disk; sound an alarm, send location information, enable or disable boot block, change boot sequence, enable or disable hard drive lock, enable or disable operating system lock, connect or disconnect from network, prohibit access to files, applications, or servers, reset passwords, change authentication requirements, change access privileges for certain users, data, applications, or servers, deny access to encryption keys, enable or disable internet connection, or enable or disable e-mail.

13. The security system of claim 8 in which the rules engine is configurable to prioritize the security actions performed based on conditional relations selected.

14. The security system of claim 13 in which the user interface program configures the security actions based on the conditional relations selected.

15. The security system of claim 8 in which the user interface program is a graphical user interface.

16. The security system of claim 8 in which the set of available security input signals are generated by a plurality of security systems.

17. A universal, customizable computer security system comprising:
a set of security input signals each relating to a possible security event; and
a rules engine responsive to the security input signals, the rules engine configurable to perform one or more security acts in response to each security input signal, the rules engine further configurable to allow a user to select one or more security actions for a combination of one or more chosen security input signals.

18. The security system of claim 17 further including a universal software interface responsive to the set of security input signals.

19. The security system of claim 17 further including a universal software output interface responsive to the security actions.

20. The security system of claim 17 in which the rules engine further includes a graphical user interface program to allow a user to customize one or more security actions to be performed in response to one or more selected security input signals.

21. The security system of claim 17 in which the security input signals correspond to motion, warning of unauthorized motion, a theft event, a motion password event, a proximity sensor signal, a zone sensor signal, a location sensor signal, an environmental security threat, detection of virus, detection of a firewall problem, connection or disconnection from a network, connection or disconnection of an A/C adapter, connection or disconnection of a docking station, connection or disconnection of a battery, connection or disconnection of a hard drive, authentication inputs including password, motion password, biometric, token, badge, and smart card, failed log-in attempt, unexpected or prohibited keyboard entries, unexpected or prohibited internet connections, user log on, user log off, unexpected user log in, user log in at unexpected times, unexpected user or administrator behavior, other hacker detection methods, unexpected file move or copy behavior, operating system suspend, operating system hibernate, or screen saver.

22. The computer security system of claim 17 in which the security actions correspond to notification of individual, group, entire network, or authority, notification via internet, modem, wired LAN, or wireless LAN, pop up warning to user, forced log off, prohibit log on, change arming state such as disarm to arm, shut down of computer and/or system, lock keyboard or mouse, turn off monitor, encrypt files, erase files, move files, destroy content of disk, sound an alarm, send location information, enable or disable boot block, change boot sequence, enable or disable hard drive lock, enable or disable operating system lock, connect or disconnect from network, prohibit access to files, applications, or servers, reset passwords, change authentication requirements, change access privileges for certain users, data, applications, or servers, deny access to encryption keys, enable or disable internet connection, or enable or disable e-mail.

23. The security system of claim 17 in which the rules engine is configurable to prioritize the security actions performed based on conditional relations selected.

24. The security system of claim 23 in which the user interface program configures the security actions based on the conditional relations selected.

25. A universal, customizable security system comprising:
a rules engine with a universal software interface responsive to a set of security input signals each relating to a possible security event, the rules engine configurable to perform one or more security actions in response to each security input signal, the rules engine further including a user interface program to allow a user to select one or more customized security actions for a combination of one or more chosen security input signals, and a universal output interface responsive to the security actions.

26. A universal, customizable security system comprising:
a rules engine responsive to a set of security input signals each relating to a possible security event, the rules engine configurable to perform one or more security actions in response to each security input signal, the rules engine further including a user interface program to allow a user to select one or more customized security actions for a combination of one or more chosen security input signals, and a universal output interface responsive to the security actions.
